(19) United States
(12) Patent Application Publication
(10) Pub. No.: US 2018/0087667 A1
(43) Pub. Date: Mar. 29, 2018

(54) SEALING ELEMENT MADE OF ELASTOMER MATERIAL

(71) Applicant: CQLT SAARGUMMI TECHNOLOGIES S.A.R.L., Remich (LU)

(72) Inventors: Daniel THIEL, Beckingen-Oppen (DE); Sébastien ROUX, St. Aubin-Celloville (FR)

(21) Appl. No.: 15/563,389

(22) PCT Filed: Jun. 10, 2016
(86) PCT No.: PCT/EP2016/063343

§ 371 Date: Sep. 29, 2017

(30) Foreign Application Priority Data
Jun. 18, 2015 (DE) 10 2015 109 795.8

(51) Int. Cl. F16J 15/02; F16J 15/10

(52) U.S. Cl. CPC F16J 15/025; F16J 15/102

(57) ABSTRACT

A sealing element that is made of elastomer material and is to be secured to a seal support, in particular a seal support on a vehicle body. The scaling element has a coating, by which the sealing element can be welded to an element that is used tbr joining the sealing element to the seal support, or by which the sealing element can be welded directly to the seal support.

The invention relates to a sealing element made from an elastomer material, which is provided for fastening to a seal support, in particular on a vehicle body, according to the preamble of claim 1.

The invention furthermore relates to an extruded seal strand which is provided for fastening to a seal support, in particular on a vehicle body, and is prefabricated having elements that for connecting the seal strand to the seal support are disposed so as to be spaced apart in the longitudinal direction of the strand, according to the preamble of claim 9.

It is known for sealing elements, in particular extruded seal strands, to be adhesively bonded to seal seats on a vehicle body, or for the former to be connected the latter by mechanical means. Plug-connection elements that latch into body bores are used above all as mechanical means. In order for the plug-connection elements to be attached to the seal strand, and in particular in order for a seal strand having plug-connection elements attached thereto to be pre-fabricated, receptacle bores into which the plug-connection elements then have to be pushed by way of a high effort in terms of labor are incorporated in the seal strand in the conventional method.

The invention is based on the object of reducing the effort for fastening sealing elements to seal supports.

This object is achieved according to the invention in that the sealing element has a coating by way of which said sealing element is weldable to an element for connection of the sealing element to the seal support, or to the seal support per se.

On account of the connection of a seal strand to elements for mechanically connecting the seal strand to the seal support, said connection according to the invention being materially integral, a seal strand that is provided with such elements can be pre-fabricated with a minor effort in terms of labor.

The coating is preferably a co-extruded coating, for example of TPE. Alternatively, a film that is applied to the seal strand and in particular is connected to the extruded strand prior to the completion of the vulcanization can be considered as coating.

The thickness of the coating is preferably in the range from 30 μm to 700 μm.

The coating is preferably composed of a thermoplastic material such that a welding capability to connection elements of thermoplastic materials is enabled, wherein in particular the materials of the coating and of the connection elements can be identical. Strand-shaped sealing elements having connection elements that are disposed so as to be spaced apart in the longitudinal direction of the strand are preferably provided.

The connection elements are in particular plug-connection elements that latch into a plug hole of the seal support.

The coating can be formed on a tube wall of a tubular sealing portion, for example, or else on a base part of a lip-shaped sealing portion of an extruded seal strand.

The connection element is preferably weldable to the sealing element by way of a base part that is adapted to the shape of the coated sealing element, wherein the access to welding apparatuses is ensured by the shape and the dimensions of the base part.

Apart from ultrasonic welding and laser welding, for example, friction welding can also be considered for the weld.

The invention will be explained in more detail hereunder by means of exemplary embodiments and of the appended drawings which refer to these exemplary embodiments and in which:

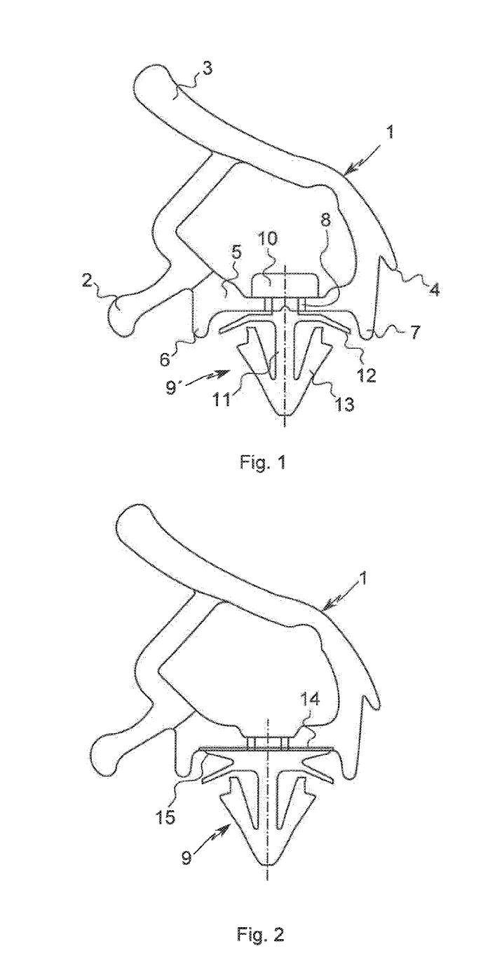

FIG. 1 shows a cross-sectional view of a seal strand having a plug-connection element that is attached thereto, according to the prior art;

FIG. 2 shows a seal strand according to the invention, which is welded to a plug-connection element, in a cross-sectional view;

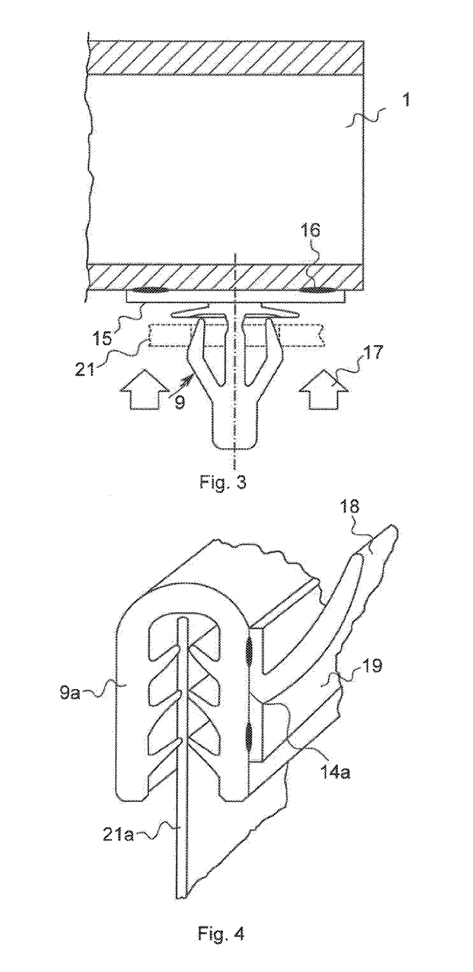

FIG. 3 shows a sectional view of the longitudinal side of the seal strand of FIG. 2; and

FIG. 4 shows a lip-shaped seal strand according to the invention, which is welded to a support strip of plastics.

An extruded seal strand shown in FIG. 1, the former being composed of EPDM, for example, comprises a tubular sealing portion 1 from which lip seals 2 to 4 project. A tube wall portion 5 that is provided for connecting to a seal support 21 shown in FIG. 3 is laterally delimited by protruding webs 6 and 7. Bores 8 which for each receiving one plug-connection element 9 are mutually spaced apart in the longitudinal direction of the strand are located in the tube wall portion 5.

A head 10 of the plug-connection element 9′ engages behind the bore 8. An annular plate 12 extends radially from a bolt part 11 of the plug-connection element 9′, so as to bear on the seal support (not shown). Barbed elements 13 which in the fitted state of the plug-connection element 9′ engage behind a plug hole in the seal support project from the bolt end.

In order for the seal strand shown in FIG. 1 to be pre-fabricated while the plug-connection elements 9′ are being attached, the heads 10 of the plug-connection elements with a high effort in labor are in each case to be introduced through the bores 8, while the tube wall portion 5 is expanded.

The seal strand shown in FIGS. 2 and 3 differs from the seal strand as per FIG. 1 in that the tube wall portion 5 does not have any bores but is provided with a coating 14. In the exemplary embodiment shown, this is a TPE coating which is co-extruded with the seal strand shown and on account of the conjoint extrusion is fixedly connected to the elastomer material of the seal strand, said material preferably being EPDM.

A plug-connection element 9 shown in FIGS. 2 and 3 has a base part 15 which when seen in the plan view projects radially across the remaining plug-connection element 9, as can be seen in particular in FIG. 3. In that the base part 15 in the longitudinal direction of the strand projects laterally according to the arrows 17, there is the potential for an ultrasonic welding apparatus to be placed thereon, or for a laser beam to be directed past the remaining plug-connection element 9 onto welding spots 16.

The TPE coating 14 can form a welded connection with the material of the plug-connection element 9, said material in the example shown likewise being composed of polyamide. A fixed connection between the seal strand and the plug-connection element 9 can thus be established by way of the TPE coating 14.

FIG. 4 shows a seal strand that is configured having a lip seal 18 and a base part 19. The base part on that side that faces away from the lip is provided with a coating 14a by way of which the seal strand is welded to a connection element 9a of plastics, of polypropylene in the example shown. The U-shaped connection element 9a is plug-fitted onto a seal support 21a in the form of a body flange.

Provided that the seal support, for example the support 21 or 21a, is composed of a weldable material, in particular a plastics material, it is to be understood that the seal support as described above can be welded directly to such a seal support.

Furthermore, the coatings 14, 14a as described above can have a plurality of layers. A plurality of layers are to be considered in particular for applied films that form the coating, for example one layer of polyethylene (PE) or polypropylene (PE), said layer facing the sealing element, and one layer of polyamide (PA), said layer facing the connection element or the seal support. These layers which each form an external layer of the coating are optionally interconnected by way of at least one intermediate layer.

That layer that faces the sealing element and that is composed of polyethylene (PE), for example, can expediently be weldable to the material of the sealing element at the vulcanization temperature, such that coating can be carried out by applying the film in the course of a vulcanization that is subsequent to the extrusion of the material strand.

In an inline process, the application of the film can be directly followed by the welding of the latter to the connection elements, wherein this welding process is facilitated by the heat of the sealing element which optionally still is at the vulcanization temperature.

The connection element is expediently attached to the sealing element with the aid of a suitable assembly installation, wherein the welding face of the connection element that faces the sealing element is first heated and fused, for example by a laser beam or a hot-air jet that is directed directly onto this face.

1.-14. (canceled)

15. A sealing element for fastening to a seal support, the sealing element being made of elastomer material, and having a coating by which said sealing element is weldable to an element for mechanical connection of the sealing element to the seal support, or to the seal support per se.

16. The sealing elementaccording to claim 15, wherein the sealing element is an extruded seal strand.

17. The sealing element according to claim 16, wherein the coating is a co-extruded coating or a film applied by lamination.

18. The sealing element according to claim 15, wherein the coating is a thermoplastic coating.

19. The sealing element according to claim 17, further comprising connection elements are disposed so as to be spaced apart in a longitudinal direction of the strand.

20. The sealing element according to claim 19, wherein the connection elements are plug-connection element that latch into plug holes in the seal support.

21. The sealing element according to claim 16, comprising a tubular sealing portion, the coating being formed on a tube wall of the tubular sealing portion.

22. The sealing element according to claim 16, comprising a lip-shaped sealing portion, the coating being formed on a base part of the lip-shaped sealing portion of the extruded seal strand.

23. The sealing element according to claim 15, wherein the connection element has a base part adapted to a shape of the coated sealing element, the connection element being weldable to the sealing element by the base part.

24. The sealing element according to claim 17, wherein the coating has a plurality of layers.

25. The sealing element according to claim 24, wherein a layer of the coating that faces the sealing element and a layer of the coating that faces the connection element or the seal support, respectively, in each case has a particular suitability for welding to the material of the sealing element or to a material of the connection element or the seal support, respectively.

26. The sealing element according to claim 25, wherein the layer that faces the sealing element is weldable to the sealing element at a vulcanization temperature of the material of the sealing element.

27. The sealing element according to claim 24, wherein the coating, in each case as an external layer, comprises one layer of polyethylene and one layer of polyamide.

28. The sealing element according to claim 27, wherein the layers are interconnected by at least one intermediate layer.

29. An prefabricated extruded seal strand for fastening to a seal support, the seal strand having connection elements for mechanically connecting the seal strand to the seal support, the connection elements being disposed so as to be spaced apart in a longitudinal direction of the strand, wherein the connection elements are connected to the seal strand in a materially integral manner.

30. The extruded seal strand according to claim 29, wherein the connection elements are welded to the seal strand by a coating of the seal strand.

31. The extruded seal strand according to claim 30, wherein the connection elements are connected to the seal strand by the coating by friction, ultrasonic and/or laser welding.
